(19) United States
(12) Patent Application Publication
(10) Pub. No.: US 2002/0046011 A1
(43) Pub. Date: Apr. 18, 2002

(54) Blind system identification method

(76) Inventors: Yoshito Higa, Tsukuba (JP); Shigenori Kinjo, Tsukuba (JP); Hirohisa Yamaguchi, Tsukuba (JP)

Correspondence Address: TEXAS INSTRUMENTS INCORPORATED, P O BOX 655474, M/S 3999, DALLAS, TX, 75265

(21) Appl. No.: 09/923,693

(22) Filed: Aug. 7, 2001

Related U.S. Application Data
(60) Provisional application No. 60/223,510, filed on Aug. 7, 2000.

(51) Int. Cl. G06F 17/10

(52) U.S. Cl. 703/2

(57) ABSTRACT

A single-input double-output blind model system identification method for estimating a channel order and reducing communications errors in a transmitted data sequence s(n), wherein the channel is represented by h₁ and h₂. The method is performed according to a SIDO model. In the method, first a computational model of the system

$${y}_{i} ( n ) = {\sum }_{j = 0}^{{L}_{adf} - 1} w ( i \cdot j ) {x}_{i} ( n - j ) ( i = 1 , 2 )$$

is provided, wherein yᵢ(n) represents an output signal, w(i,j) is an adaptive digital filter (“ADF”) wherein j represents a j-th coefficient of the ADF, L_{adf} represents a tap length of the ADF, and xi represents a signal received from the channel corresponding to a transmitted signal s.

Adaptive computation is performed by computing a minimum L_{adf} to determine a mean squared error (“MSE”) of the output signals y₁(n) and y₂(n) lower than a predetermined threshold. The number of coefficients of the ADF is reduced, and the step of performing adaptive computation is repeated until the number of coefficients is a number m at which the MSE does not decrease. Finally, the step of performing adaptive computation is repeated, with the number of coefficients of m+1 or larger.

This application claims priority under 35 U.S.C. 119(e)(1) of provisional application number 60/223,510, filed Aug. 7, 2000.

### TECHNICAL FIELD OF THE INVENTION

This invention relates to error reduction in communications systems, and more particularly relates to an improved method of blind system identification.

### BACKGROUND OF THE INVENTION

Reliable communication frequently requires active reduction of errors. For digital communications, intersymbol interference (“ISI”) is a limiting factor in many environments, for example. To reduce errors due to ISI and other factors, and thereby achieve high speed and reliable communication, channel identification and equalization are performed. This can be accomplished by either sending a training sequence or by designing the equalizer by based on a priori knowledge of the channel. However, training sequences waste a portion of the transmission time, and a priori knowledge of the channel is not always available, for example in mobile RF communications systems.

In contrast to these prior art equalization methods a technique is a technique called “blind deconvolution,” or “blind equalization,” that does not require the use of a training sequence. Rather, the statistical properties of the transmitted signals are used to perform equalization at the receiver, without access to the symbols being transmitted.

Significant attention has been paid to blind equalization techniques based on a Single-Input Multiple-Output (“SIMO”) model. For example, a description blind equalization using a SIMO model can be found in the following articles: Y. Higa and H. Ochi, “A Gradient Type Algorithm for Blind System Identification and Equalizer Based on Second Order Statistics,” TI Technical Activity Report, 1998; L. Tong, G. Xu and T. Kailath, “Blind Identification and Equalization Based on Second-Order Statistics: A Time Domain Approach,” IEEE Trans. Information Theory, Vol. 40, pp. 340-349, March 1994; L. Tong, G. Xu, B. Hassibi and T. Kailanth, “Blind Identification and Equalization Based on SEcond-Order Statistics: A Frequency Domain Approach,” IEEE Trans. Information Theory, Vol. 41, pp. 329-334, January 1995; G. Xu, H. Liu, L. Tong and T. Kailanth, “A Least-Squares Approach to Blind Channel Identification,” IEEE Trans. Signal Processing, Vol. 43, pp. 2982-2993, December 1995; Hanks H. Zeng and Lang Tong, “Blind Channel Estimation Using the Second-Order Statistics: Algorithms,” IEEE Trans. Signal Processing, Vol. 45, pp. 1919-1930, August 1997; and Moulines, E. and Duhamel, P., “Subspace Methods for the Blind Identification of Multichannel FIR Filters,” IEEE Trans. Signal Processing, Vol. 43, pp. 516-525, 1995. However, realization of the methods described in the foregoing references has been difficult to achieve by real time processing, because these methods are deterministic. In addition, these methods rely on perfect knowledge of the true channel order.

### SUMMARY OF THE INVENTION

Accordingly, there is a need for an improved blind equalization method. According to the invention, a single-input double-output blind model system identification method is provided for estimating a channel order and reducing communications errors in a transmitted data sequence s(n), wherein the channel is represented by h₁ and h₂. The method is performed according to a SIDO model. In the method, first a computational model of the system

$${y}_{i} ( n ) = {\sum }_{j = 0}^{{L}_{adf} - 1} w ( i \cdot j ) {x}_{i} ( n - j ) ( i = 1 , 2 )$$

is provided, wherein yᵢ(n) represents an output signal, w(i,j) is an adaptive digital filter (“ADF”) wherein j represents a j-th coefficient of the ADF, L_{adf} represents a tap length of the ADF, and xi represents a signal received from the channel corresponding to a transmitted signal s. Adaptive computation is performed by computing a minimum L_{adf} to determine a mean squared error (“MSE”) of the output signals y₁(n) and y₂(n) lower than a predetermined threshold. The number of coefficients of the ADF is reduced, and the step of performing adaptive computation is repeated until the number of coefficients is a number m at which the MSE does not decrease. Finally, the step of performing adaptive computation is repeated, with the number of coefficients of m+1 or larger.

These and other features of the invention will be apparent to those skilled in the art from the following detailed description of the invention, taken together with the accompanying drawings.

### BRIEF DESCRIPTION OF THE DRAWINGS

FIG. 1 is a block diagram of a blind system identification Single-Input Double-Output model;

FIG. 2 is a graph showing learning curves for the system of FIG. 1, in which the inventive method is employed;

FIG. 3 is a graph showing zeros of certain terms from FIG. 1 in the z-plane.

FIG. 4 is a graph showing additional learning curves for the system of FIG. 1, in which the inventive method is employed;

FIG. 5 is a graph showing a learning curve of NIRER in which the inventive method is employed; and

FIG. 6 is a flow chart showing a preferred embodiment of the method of the present invention.

### DETAILED DESCRIPTION OF THE PREFERRED EMBODIMENT

The numerous innovative teachings of the present invention will be described with particular reference to the presently preferred exemplary embodiments. However, it should be understood that this class of embodiments provides only a few examples of the many advantageous uses and innovative teachings herein. In general, statements made in the specification of the present application do not necessarily delimit the invention, as set forth in different aspects in the various claims appended hereto. Moreover, some statements may apply to some inventive aspects, but not to others.

FIG. 1 is a block diagram showing a structure of blind system identification according to a Single-Input Double-Output (“SIDO”) model. In this system h₁ and h₂ represent the transmission channel expressed by the SIDO model. Initially, it is assumed that h₁ and h₂ are of finite length L_{sys}, in order to simplify the following discussion. Thus,

h₍ᵢⱼ₎=0 (i=1, 2, j<0, L_{sys}≦j), Eq. (1)

where j stands for the j-th coefficient of the hᵢ. In the figure, s(n) represents the source signal, while x₁(n) and x₂(n) represent received signals represented by the dual outputs of the SIDO model, respectively. The blocks labeled w₁ and w₂ are are adaptive digital filters (“ADFs”) with tap length L_{adf}. The term w₍ᵢⱼ₎ denotes the j-th coefficient of the respective wᵢ. The output signals of the w₁ and w₂ ADFs are represented by y₁(n) and y₂(n), respectively. The term e(n) represents an error signal.

A blind system identification algorithm based on the SIDO model presented in conjunction with FIG. 1, above, updates the coefficients of the two ADFs in order to generate outputs identical to one another. In terms of the ADF wᵢ, the output signal yᵢ(n) can be expressed as

$${y}_{i} ( n ) = {\sum }_{j = 0}^{{L}_{adf} - 1} w ( i \cdot j ) {x}_{i} ( n - j ) ( i = 1 , 2 ) \qquad Eq . ( 2 )$$

To achieve a blind system identification, a cost function of the method is defined as the Mean Squared Error (“MSE”) of the output signals y₁(n) and y₂(n), as follows:

$$\begin{matrix}J = E [ {e}^{2} ( n ) ] \\ = E [ {\vert {y}_{1} ( n ) - {y}_{2} ( n ) \vert}^{2} ] ,\end{matrix} \qquad Eq . ( 3 )$$

where E[.] denotes the statistical expectation operator. Substituting Equation (2) into Equation (3) yields:

$$J = E [ {\vert {\sum }_{j = 0}^{{L}_{adf} - 1} w ( 1 , j ) {x}_{1} ( n - j ) - {\sum }_{j = 0}^{{L}_{adf} - 1} w ( 2 , j ) {x}_{2} ( n - j ) \vert}^{2} ] . \qquad Eq . ( 4 )$$

To avoid a trivial solution, such as w(i,j)=0, assume that the first coefficient of w(1,i) is unity, i.e., w(1,0)=1. Then:

$$J = E [ {\vert {x}_{1} ( n ) + {\sum }_{j = 0}^{{L}_{adf} - 1} w ( 1 , j ) {x}_{1} ( n - j ) - {\sum }_{j = 0}^{{L}_{adf} - 1} w ( 2 , j ) {x}_{2} ( n - j ) \vert}^{2} ] . \qquad Eq . ( 5 )$$

Now, re-writing Equation (5) in matrix form:

J=└{x₁(n)+w₁^{T}x₁(n)−w₂^{T}x₂(n)}²┘. Eq. (6)

where

x₁(n)=[x₁(n−1)x₂(n−1) . . . x₁(n−L_{adf}+1)]^{T}, Eq. (7)

x₂(n)=[x₁(n)x₂(n−1) . . . x₂(n−L_{adf}+1)]^{T}, Eq. (8)

w₁=[w(1,1)w(1,2) . . . w(1,L_{adf}−1]^{T}, and Eq. (9)

w₂=[w(2,0)w(2,1) . . . w(2,L_{adf}−1]^{T}. Eq. (10)

The terms x(n) and w are defined as follows:

$$\begin{matrix}x ( n ) = [ \begin{matrix}- {x}_{1} ( n ) \\ {x}_{2} ( n )\end{matrix} ] . & Eq . ( 11 ) \\ w = [ \begin{matrix}{w}_{1} \\ {w}_{2}\end{matrix} ] . & Eq . ( 12 )\end{matrix}$$

Hence, Equation (6) may be rewritten as:

$$\begin{matrix}J = E [ {\{ {x}_{1} ( n ) - {w}^{T} x ( n ) \}}^{2} ] \\ = E [ {x}_{1}^{2} ( n ) - 2 {x}_{1} ( n ) {w}^{T} x ( n ) + {w}^{T} x ( n ) {x}^{T} ( n ) w ] \\ = {σ}_{{x}_{1}}^{2} - 2 {w}^{T} P + {w}^{T} Rw ,\end{matrix} \qquad Eq . ( 13 )$$

where σₓ_{₁}², R and P are the variance of x₁, auto-correlation matrix of x(n) and cross-correlation matrix of x₁(n) and x(n), respectively. Matrix R is a full rank matrix when the terms h₁, and h₂ have no common zeros and the orders of w₁ and w₂ are equal to that of the terms h₁ and h₂, respectively. Equation (13) has the same form as a cost function with ordinary adaptive filters. Hence, various adaptation algorithms can be adapted, using the principles of the present invention, to minimize the cost function.

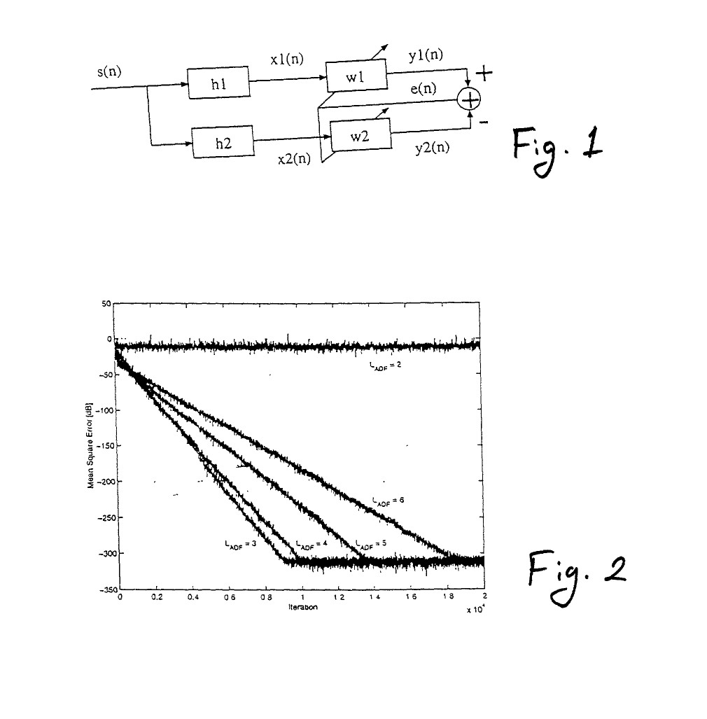

The inventive method for estimating the order of an unknown system will now be described in detail. FIG. 2 shows learning curves for the MSE of |y₁(n)−y₂(n)|, with several tap lengths for the w₁ and w₂ ADFs. Table 1 shows simulation parameters for these several tap lengths.

TABLE 1

| Source Signal | White signal |
|---|---|
| | σₛ² = 1.0, \overline{s} = 0 |
| Additive Noise | None |
| Channel (L_{sys} = 3) | h₁ = [0.7, 0.3, 0.2] |
| | h₂ = [0.3, 0.7, 0.2] |
| Algorithm | NLMS |
| Tap Length (L_{adf}) | 2−, 3−, 4−, 5− and 6− tap |
| Step size | 1.0 |

From FIG. 2 it can be seen that the MSE of |y₁(n)−y₂(n)| converges when L_{adf}≧L_{sys}.

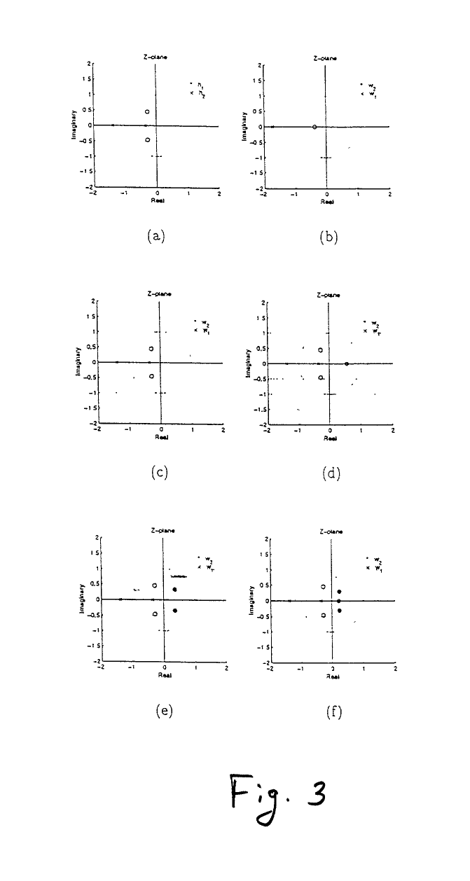

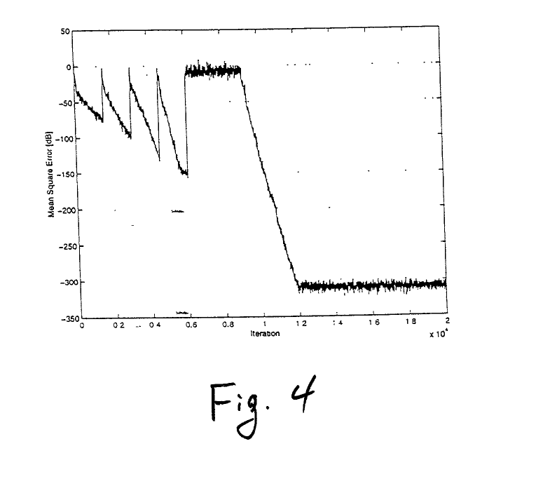

FIG. 3 shows zeros of the terms h₁, h₂, w₁, and w₂ in the z-plane. Letting Wᵢ(z) and Hᵢ(z) denote the transfer function of wᵢ and hᵢ, respectively, then FIG. 3 shows that W₁(z)=H₂(z)C(z) and W₂(z)=H₁(z)C(z) when L_{adf}≧L_{sys}. The term C(z) represents an arbitrary polynomial, and the order of C(z) is L_{adf}−L_{sys}.

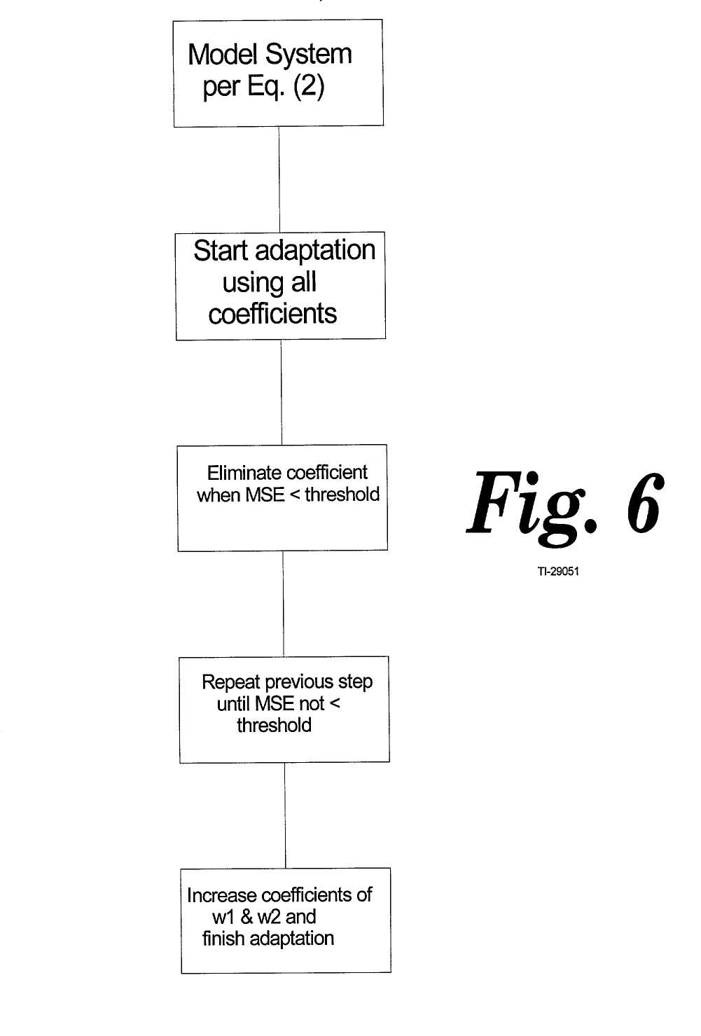

Based on the above, the orders of the unknown system can now be identified, by finding the min{L_{adf}} which gives an MSE of |y₁(n)−y₂(n)| lower than a selected threshold. Given the above analysis and inventive algorithms, the inventive method is as follows, as illustrated in FIG. 6.

1. First, the system is modeled, per Eq. (2).

2. Then, adaptation is started, using all coefficients for w₁ and w₂.

3. Eliminate one coefficient for w₁ and w₂ when the MSE is lower than a desired threshold. Repeat adaptation.

4. Repeat step 3 until the MSE does not become lower than the threshold.

5. Increase w₁ and w₂ by one coefficient and stop adjusting the order of w₁ and w₂ when the MSE does not become lower than the threshold. Finish adaptation.

The effectiveness of the inventive blind system identification can be readily demonstrated by describing the results of a computer simulation, which will now be done. Normalized Impulse Response Estimation Ratio (“NIRER”) is chosen to be the measure of evaluation. In this simulation, a Normalized Least Mean Square (“NLMS”) algorithm has been employed for adaptation. The simulation is carried out under no additive noise. Table 2 shows simulation parameters.

$$NIRER = 10 \times {log}_{10} \{ {\sum }_{i = 0}^{{L}_{adf} - 1} {( \frac{{h}_{( 1 , i )}}{‖ {h}_{1} ‖} - \frac{{w}_{( 2 , i )}}{‖ {w}_{2} ‖} )}^{2} + {\sum }_{i = 0}^{{L}_{adf} - 1} {( \frac{{h}_{( 2 , i )}}{‖ {h}_{2} ‖} - \frac{{w}_{( 1 , i )}}{‖ {w}_{1} ‖} )}^{2} \} , \qquad Eq . ( 14 )$$

where

$$‖ {h}_{i} ‖ = \sqrt{{\sum }_{j = 0}^{{L}_{adf} - 1} {\vert {h}_{( i , j )} \vert}^{2}} . \qquad Eq . ( 15 )$$

FIG. 4 shows a learning curve of the MSE of |y₁(n)−y₂(n)|. First, six coefficients are employed for w₁ and w₂ for adaptation. We can see in the figure that the MSE of |y₁(n)−y₂(n)| is decreasing each iteration using six coefficients. After 1500 iterations, one coefficient is eliminated, so that the ADFs have only five coefficients. In the figure it can be seen that from 1500 to 3000 iterations the MSE of |y₁(n)−y₂(n)| is decreasing, demonstrating that five coefficients are sufficient for the ADFs. Similarly, another coefficient is eliminated after 3000 and 4500 iterations. It can be seen in the figure that the ADFs still have enough coefficients to reduce the MSE. After 6000 iterations, the ADFs have only two coefficients, which is insufficient for the adaptation, as it can be seen in the figure that the MSE is not decreasing in that region of the figure. As a result, it has been learned that the order of the unknown system is three. Based on this, one is added to the number of effective coefficients at approximately 9000 iterations. It can be seen in the figure that above 9000 iterations the MSE is, indeed, decreasing.

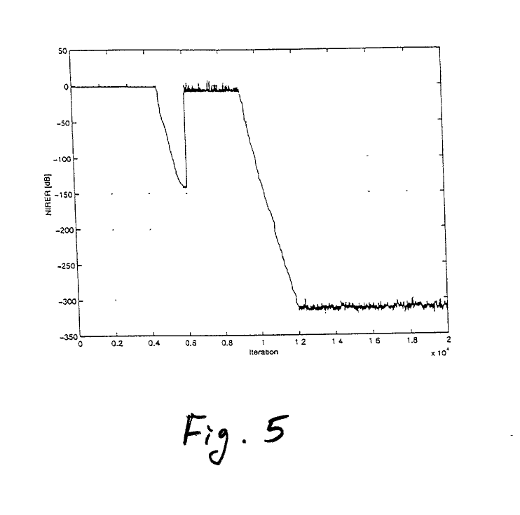

FIG. 5 shows a learning curve of NIRER in which the inventive method is employed. From the figure it can be seen that the inventive method has clearly identified the unknown system under no additive noise.

Although the present invention and its advantages have been described in detail, it should be understood that various changes, substitutions and alterations can be made herein without departing from the spirit and scope of the invention as defined by the appended claims.

What is claimed is:

1. A single-input double-output blind model system identification method for estimating a channel order and reducing communications errors in a transmitted data sequence s(n), wherein the channel is represented by h₁ and h₂ according to the SIDO model, comprising the steps of:
providing a computational model of the system
$${y}_{i} ( n ) = {\sum }_{j = 0}^{{L}_{adf} - 1} w ( i , j ) {x}_{i} ( n - j ) ( i = 1 , 2 )$$
wherein
yᵢ(n) represents an output signal,
w(i,j) is an adaptive digital filter (“ADF”) wherein j represents a j-th coefficient of the ADF,
L_{adf} represents a tap length of the ADF, and
xi represents a signal received from the channel corresponding to a transmitted signal s;
performing adaptive computation by computing a minimum L_{adf} to determine a mean squared error (“MSE”) of the output signals y₁(n) and y₂(n) lower than a predetermined threshold;
reducing the number of coefficients of the ADF and repeating the step of performing adaptive computation until the number of coefficients is a number m at which the MSE does not decrease; and
repeating the step of performing adaptive computation with the number of coefficients of m+1 or larger.

2. A method according to claim 1 in which the step of performing adaptive computation is performed by performing a normalized least mean square algorithm computation.
